(19) United States
(12) Patent Application Publication
(10) Pub. No.: US 2026/0278806 A1
(43) Pub. Date: Sep. 17, 2026

(54) 3D PERCEPTION AND MULTI-SENSOR OBJECT TRACKING FOR MONITORED ENVIRONMENTS USING MACHINE LEARNING

(71) Applicant: NVIDIA Corporation, Santa Clara, CA (US)

(72) Inventors: Zheng TANG, Bothell, WA (US); Ganapathy Seshadri Cadungude AIYER, San Jose, CA (US); Kartikay THAKKAR, Pune (IN); Yun HE, Santa Clara, CA (US); Akshay AGRAWAL, Santa Clara, CA (US); Sameer Satish PUSEGAONKAR, San Francisco, CA (US); Yizhou WANG, Milpitas, CA (US); Yuxing WANG, Burlingame, CA (US); Cheng-Yen YANG, Bellevue, WA (US); Tim Benjamin MEINHARDT, Munich (DE); Ibrahim Orcun CETINTAS, Munich (DE); Benjamin Joaquim MISSAOUI, Modena (IT); Laura LEAL-TAIXE, Florence (IT); Sujit BISWAS, Newark, CA (US)

(21) Appl. No.: 19/310,767

(22) Filed: Aug. 26, 2025

(30) Foreign Application Priority Data
Mar. 14, 2025 (IT) 102025000005252

(51) Int. Cl. G06T 7/20; G06V 10/82; G06V 20/52; G06V 40/20

(52) U.S. Cl. CPC G06T 7/20; G06V 10/82; G06V 20/52; G06V 40/20

(57) ABSTRACT

In various embodiments, 3D perception and multi-sensor object tracking for monitored environments using machine learning are provided. A 3D perception-based real-time location system is disclosed that tracks multiple objects within a monitored area based on 3D behavior data from multiple image sensors, producing 3D tracking solutions for detected entities moving within the environment. The system may leverage synchronized 3D behavior data computed from optical image sensors grouped into sensor pods. The system may include a machine learning-based tracking framework that includes a spatial aggregation model and a temporal tracking model. The spatial aggregation model aggregates 3D perception data across the sensor pods, while the temporal tracking model refines object associations across time. The spatial aggregation model and/or the temporal tracking model may comprise a graph neural network (GNN). In some embodiments, a machine learning-based tracking framework may comprise a state management system to augment inputs into the temporal tracking model.

### CROSS-REFERENCE TO RELATED APPLICATIONS

This application is a U.S. Patent application claiming priority to, and the benefit of, Italian Patent Application No. 102025000005252, titled “3D PERCEPTION AND MULTI-SENSOR OBJECT TRACKING FOR MONITORED ENVIRONMENTS USING MACHINE LEARNING”, filed on Mar. 14, 2025, which is incorporated by reference in its entirety.

This application is related to U.S. patent application Ser. No. 19/079,809, entitled “3D MULTI-SENSOR PERCEPTION AND OBJECT TRACKING”, filed on Mar. 14, 2025, which is incorporated by reference in its entirety.

### BACKGROUND

Multi-target multi-camera (MTMC) tracking is a computer vision-based technology that simultaneously monitors and tracks the movements of numerous subjects (targets) across multiple camera views-taking input from video feeds captured by multiple (potentially non-overlapping) cameras, and applying algorithms and/or machine learning techniques to analyze video streams to track and identify subjects of interest. MTMC tracking may be used in applications such as security and surveillance, vehicle traffic monitoring, monitor activities in transit, factories and warehouses, in retail analytics to monitor customer behaviors in a retail store, and/or for crowd management/public safety at events, gatherings, or public spaces.

### SUMMARY

Embodiments of the present disclosure relate to three-dimensional (3D) perception and multi-sensor object tracking for monitored environments using machine learning. Systems and methods are disclosed that may be used to track multiple objects within a monitored area based on 3D behavior data, across the views of a plurality of image sensors, to produce 3D tracking solutions for a plurality of subjects.

In contrast to conventional real-time tracking systems, embodiments described herein provide for a 3D perception-based Real-Time Location System (3D-RTLS) that leverages 3D perception data (e.g., birds-eye-view image data) from multiple optical image sensors, neural network-based spatial and temporal processing, and graphics processing unit (GPU)-based processing, to provide accurate real-time object tracking across a monitored environment. This system enhances the accuracy and reliability of object tracking by utilizing advanced 3D perception techniques. The 3D-RTLS may input behavior data derived from sensor data from multiple synchronized image sensors grouped into image sensor pods. An image sensor pod captures optical sensor data over a cumulative field of view, which may overlap with other pods. The 3D perception framework processes this data to generate pod behavior data, including, for example, 3D bounding shapes, subject classifications, short-term tracking data, timestamps, and object identifications (IDs). In some embodiments, a Sparse four-dimensional (4D)-based architecture may be used in the 3D perception framework for 3D object detection and tracking. The 3D perception framework may generate object embeddings used for assigning object IDs, enhancing the reliability of localization and tracking results. The 3D bounding shapes produced by the framework provide detailed information about the tracked subjects, such as dimensions, shape, size, and orientation angle.

In some embodiments, an 3D-RTLS may include a pod data preprocessor stage and a machine learning-based tracking framework stage. The pod data preprocessor stage synchronizes pod behavior data across multiple pods and, in some embodiments, may fuse 3D detection results with single-camera tracking outputs. The machine learning-based tracking framework stage may include a spatial aggregation model and a temporal tracking model. The spatial aggregation model of the machine learning-based tracking framework stage may aggregate the 3D perception data from multiple pods, which may address challenges such as object occlusions and overlapping objects. The temporal tracking model may then refine object associations across time, maintaining consistent global IDs for long-term tracking and handling occlusions and abrupt movements. In some embodiments, the machine learning-based tracking framework stage may further comprise a state management system to augment inputs into the temporal tracking model. The state management system may receive location and/or trajectory information for tracked subjects from the output of the spatial aggregation model and maintain object states so that the temporal tracking model can better determine associations between tracked subjects over time, for example to recover occluded subjects and/or to enhance robustness in tracking objects across discontinuities in image data due to dynamic and crowded environments.

In some embodiments, one or both of the spatial aggregation model and/or the temporal tracking model as described herein may comprise and be implemented using graph neural networks (GNNs). GNNs may be used effectively to model complex relationships within graph-structured data (e.g., a tuple of vertices and edges) and trained to adapt to various environments and scenarios, such as for associating and tracking objects from behavior data as described herein. In some embodiments, other neural network architectures may be used to implement the spatial aggregation model and/or the temporal tracking model. For example, in some embodiments, machine learning transformer models may be trained to perform the functions of the spatial aggregation model and/or the temporal tracking model.

### BRIEF DESCRIPTION OF THE DRAWINGS

The present systems and methods for 3D perception and multi-sensor object tracking for monitored environments using machine learning are described in detail below with reference to the attached drawing figures, wherein:

FIG. 1 is a data flow diagram for an example 3D perception-based Real-Time Location System (3D-RTLS), in accordance with some embodiments of the present disclosure;

FIGS. 2A and 2B are diagrams illustrating an example of grouping of optical image sensors into image sensor pods, in accordance with some embodiments of the present disclosure;

FIG. 2C is a diagram providing a rendered illustration of pod behavior data, in accordance with some embodiments of the present disclosure;

FIG. 3 is a data flow diagram illustrating an example machine learning-based tracking framework, in accordance with some embodiments of the present disclosure;

FIGS. 4A and 4B are diagrams that illustrate example user interfaces that may be displayed by the 3D-RTLS, in accordance with some embodiments of the present disclosure;

FIG. 5 is a flow chart diagram for an example method for a 3D perception-based Real-Time Location System, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to 3D perception and multi-sensor object tracking for monitored environments using machine learning.

Historically, camera-based tracking technologies have involved either single-object tracking (SOT) or multi-object tracking (MOT) based on image data from a single camera. More recently, multi-camera-based tracking approaches have leveraged developments in multi-camera networks to apply techniques for providing comprehensive monitoring of an area from multiple viewpoints. However, multi-camera tracking introduces complexities with respect to tracking subjects across multiple camera views-including accurate synchronization and calibration between the cameras, addressing appearance changes in a tracked entity that may vary with the viewpoint, and fusing data from different video streams to distinctly define subjects and their associated trajectory tracks.

While object Re-identification (Re-ID) and other advanced matching algorithms have been developed that can take the outputs of object detection algorithms and match them to compute individual trajectories, those techniques face difficulties with respect to scalability and supporting real-time MTMC tracking from live video streams. Other real-time location systems (RTLSs) have been proposed that perform two dimensional (2D) perception-based multi-target tracking using real-time (e.g., live) streaming data from multiple sensors based on generating behavior clusters (e.g., a cluster including a set of similar detected behaviors) using hierarchical clustering, where each behavior cluster represents a trackable subject within an area monitored by a set of optical image sensors, and is associated with an anchor and identifier. With this system, inputs are obtained from individual 2D camera tracking results, which may then be projected into three dimensions to perform 3D tracking. While effective for basic scenarios, 2D perception-based RTLSs rely on predefined rules, making them less adaptive to the rich data available for modern learning-based methods. For example, when projecting single-camera results from 2D into 3D, uncertainty is introduced due to the difficulty in accurately determining the foot-point for a person. This challenge extends to different object classes, such as vehicles or boxes, where locating the center foot-point based solely on 2D detection results is problematic. Consequently, projecting these results into 3D introduces additional uncertainty. Moreover, for complex scenes, extensive fine-tuning is required to maintain accuracy, reducing the system's practicality.

In contrast to prior location and tracking systems, the 3D perception-based Real-Time Location System (3D-RTLS) described herein addresses the limitations of traditional Multi-Target Multi-Camera Tracking (MTMC) systems and legacy 2D perception-based location systems. In some embodiments, the 3D-RTLS leverages 3D perception birds-eye-view (BEV) data from multiple camera sensors deployed across a monitored environment, neural network-based spatial and temporal processing of the 3D perception BEV data, and GPU-based processing, to provide a real-time location system with accurate object tracking across the monitored environment.

As described herein, an 3D-RTLS may input BEV behavior data (e.g., BEV frames) comprising one or more sets of synchronized BEV behavior data, where an individual set may represent BEV behavior data associated with a defined “pod” or “group” of image sensors (which may comprise physical and/or virtual image sensors). That is, an individual image sensor may capture optical sensor data (e.g., BEV sensor data) that captures a field of view covering at least a region of the monitored environment as viewed by that image sensor, whereas a pod of image sensors captures optical sensor data over a cumulative field of view corresponding to the combined fields of view of the individual image sensors that make up that pod. In some embodiments, a pod of image sensors may capture images from a field of view that at least partially overlaps with a field of view of another pod of image sensors. In various embodiments, optical sensor data may include data generated by monocular and/or stereo image sensors.

Provided the optical sensor data from a pod of image sensors, a 3D perception framework (such as, but not limited to, a Sparse 4D framework) may generate BEV behavior data for that pod, which may be referred to as BEV pod behavior data. For example, the 3D perception framework may comprise a 3D perception-based machine learning framework having one or more machine learning models that input the optical sensor data captured by the image sensors of a pod, and infer BEV pod behavior data that may include, but is not limited to, 3D bounding shapes (e.g., bounding boxes) corresponding to detected subjects (e.g., entities such as objects, persons, animals, machines, etc.) within a field of view, an inferred subject classification for a detected subject enveloped by a 3D bounding shape (e.g., the object is classified as being a person, a box, a forklift, etc.), short-term tracking data for those detected subjects, BEV image frame timestamps, and/or object identifications (object IDs) associated with the distinct objects detected in the field of view associated with that pod. It should be noted that provided with 3D image frames (e.g., 3D BEV frames), 3D bounding shapes may be directly generated without having to rely on projections of 2D object detections on a ground plane-which avoids uncertainties associated with foot-point localization and defining a specific ground plane. Furthermore, the 3D-RTLS described herein is able to accommodate objects in the entire 3D space, which offers improved flexibility and accuracy in comparison to prior 2D-based detection methods. The 3D perception framework may further output embeddings (e.g., behavior embeddings) that characterize the appearance of one or more features of a tracked subject, which essentially avoids the need to rely on single-camera tracking results, as was done in prior 2D perception approaches.

As mentioned, in some embodiments a 3D perception framework may be implemented using a Sparse 4D-based architecture. A Sparse 4D architecture is a machine learning-based framework designed for 3D object detection and tracking using sparse spatial-temporal fusion. In contrast with BEVFormer frameworks, the 3D perception framework can generate embeddings and assign object IDs in addition to performing 3D object detection. In some embodiments, for each object detected by the 3D perception framework, multiple keypoints may be assigned and projected onto multi-view, multi-scale, and multi-timestamp image features to sample corresponding features. By using a 3D perception-based machine learning-based framework, a 3D perception framework model may be trained on detecting the 3D bounding shapes, resulting in more reliable localization and tracking results in 3D space, and providing BEV pod behavior data that may be more readily leveraged by the subsequent 3D-RTLS tracking architecture (e.g., the neural network-based spatial and temporal processing) as discussed herein. Having 3D bounding shapes produced by the 3D perception framework around a tracked subject may generate a richer dataset of BEV pod behavior data for further processing than merely having 3D location data for a tracked subject, because a 3D bounding shape can further indicate characteristics such as dimensions, shape, size, and/or angle of the object. The 3D perception framework, by generating embeddings and assigning object IDs to track subjects, and understanding associations between 3D bounding shapes, realizes a less complex 3D perception-based detection pipeline for the initial stage of the 3D-RTLS as compared to prior approaches.

In some embodiments, the 3D-RTLS may comprise a pod data preprocessor stage that receives the BEV pod behavior data from the 3D perception framework stage for the pods of image sensors used to cover the monitored environment. For example, an area monitoring system may include multiple optical sensors distributed throughout a monitored environment. The 3D perception framework stage may initialize multiple 3D perception pipelines, wherein a 3D perception pipeline collects optical image data from the image sensors of a pod and applies a model (e.g., a Sparse 4D-type architecture) to generate a set of the BEV pod behavior data for that pod. In some embodiments, a 3D perception pipeline can process the image data feed for 15 to 20 image sensors that are grouped into a pod. For example, for a 100-camera system, the sensor may be grouped into ten pods with 10 image sensors per pod that are located in spatial proximity to each other in order to cover a defined monitoring region of the monitored environment. With this configuration, the BEV pod behavior data for a given pod may be considered as representing BEV behavior data for a virtualized composite sensor for its particular monitoring region of the monitored environment.

The pod data preprocessor stage of the 3D-RTLS may receive the BEV pod behavior data for multiple pods and synchronize metadata of the BEV pod behavior data across the multiple BEV sensor pods with respect to temporal alignment. In some embodiments, the pod data preprocessor stage may fuse 3D detection results with single-camera tracking outputs, creating a unified dataset for further processing. The output from the pod data preprocessor stage (e.g., synchronized BEV pod behavior data) may be applied to a machine learning-based tracking framework stage that may comprise a spatial aggregation model and a temporal tracking model.

The spatial aggregation model may receive the synchronized BEV pod behavior data from the pod data preprocessor stage and aggregate the 3D perception data across the BEV sensor pods. By aggregating data from multiple BEV sensor pods, the spatial aggregation model can process BEV behavior data from hundreds or even thousands of image sensors simultaneously. This capability ensures scalability, making the 3D-RTLS suitable for large-scale environments such as warehouses, urban spaces, and autonomous logistics operations. Moreover, the spatial aggregation model produces an aggregated set of BEV pod behavior data that addresses challenges such as occlusions and overlapping objects by leveraging relationships within and across BEV sensor pods. The output is an aggregated dataset representing the entire monitored area. In some embodiments, the spatial aggregation model may aggregate the BEV pod behavior data from the multiple sensor pods into a topic map, where each detected object is represented by its own 3D bounding shape and tagged with its assigned object ID. In some embodiments where two or more BEV pod behavior datasets include at least partially overlapping data, the spatial aggregation model may deduplicate bounding shapes by combining bounding shapes in overlapping regions and assigning an object ID to the resulting bounding shape.

The result of the spatial aggregation performed by the spatial aggregation model (e.g., an aggregated behavior dataset) may be provided as input to the temporal tracking model. The temporal tracking model refines object associations across time (e.g., across a sequence of data frames of the aggregated behavior dataset) to establish consistency in object IDs and improve long-term tracking. By associating objects across BEV image frames, the temporal tracking model maintains consistent global IDs for long-term object tracking. Additionally, the temporal tracking model enables the 3D-RTLS to recover from occlusions and handle abrupt object movements by associating currently tracked entities with those previously detected and tracked in prior frames. In some embodiments, the temporal tracking model addresses tracking discontinuities by using prior frame tracking and position data to predict a current position for an object and associating that prediction with a currently observed object. The temporal tracking model may implement extended object tracking beyond the limited tracking abilities of the Sparse 4D framework. For example, for an individual sensor pod, the tracking results available from a Sparse 4D framework rely on a short memory bank to run the perception pipeline efficiently. This short-term memory means that when objects collide or when there is uncertainty, new IDs may be initiated, making the results reliable only for short-term tracking (e.g., a few hundred frames). For the Sparse 4D framework to provide long-term tracking (e.g., 1000 to 2000 frames), a larger memory bank would be required. As such, single-pod tracking results from a Sparse 4D framework having limited reliability for long-term tracking due to this memory limitation. In contrast, the temporal tracking model may comprise a sufficiently larger lookback window to resolve uncertainties or ambiguities in object tracking over longer periods. The temporal tracking model refines the tracking results to ensure consistency and reliability over longer periods. The output from the temporal tracking model may be generated in real-time, including timestamps and 3D bounding shapes for each global object ID.

The spatial aggregation model and/or temporal tracking model may leverage multiple information sources, including appearance features, spatial distance, velocity, and potentially more, to achieve robust performance. In some embodiments, one or both of the spatial aggregation model and/or the temporal tracking model as described herein may comprise and be implemented using one or more graph neural networks (GNNs). GNNs may be used effectively to model complex relationships within graph-structured data (e.g., a tuple of vertices and edges) and trained to adapt to various environments and scenarios, such as for associating and tracking objects from behavior data as described herein. For example, a GNN architecture may implicitly model interactions between tracked entities (e.g., subjects such as people, objects, animals, machines, etc.), because the graph may be structured so that each edge in the graph will correspond to a specific tracked entity. As such, if one edge has one valid connection, then that object cannot correspond to any of the other edges in the graph, and for any given vertices (e.g., a node), only one of the incident edges connected to that node can be true. GNN models, moreover, are adept at being trained on large datasets to optimize performance and accuracy and are readily deployable on GPUs. Furthermore, by offloading 3D perception data processing tasks to one or more GPUs, data from multiple 3D perception pipelines corresponding to hundreds or thousands of image sensors may be computed in parallel by the spatial aggregation model and/or temporal tracking model while maintaining performance for tracking subjects across the monitored environment in real-time. That is, as opposed to executing resource-intensive algorithms to compute clustering and Hungarian matching such as for 2D perception-based tracking systems, a GNN may learn through training how to spatially aggregate and temporally track objects based on BEV pod behavior data. For example, in some embodiments, the machine learning-based tracking framework of the 3D-RTLS may be implemented using a spatial GNN and/or temporal GNN. To train such GNNs, the models may be provided with training data comprising behaviors (e.g., embeddings associated with tracked subjects) with their 3D bounding shapes across different batches (e.g., micro-batches of one second), and learn to associate those with a persistent object ID that should be associated with the same tracked subject.

In some embodiments, other neural network architectures may be used to implement the spatial aggregation model and/or the temporal tracking model. For example, in some embodiments, machine learning transformer models may be trained to perform the functions of the spatial aggregation model and/or the temporal tracking model. For example, an architecture similar to a GNN may be implemented using a transformer where message passing steps in a GNN are performed using one or more layers of a transformer model trained to mimic the message passing function.

In some embodiments, the machine learning-based tracking framework stage may further comprise a state management system to augment inputs into the temporal tracking model. For example, in some embodiments, the state management system may receive location and/or trajectory information for tracked subjects from the output of the spatial aggregation model and maintain object states (e.g., for up to 10 seconds) so that the temporal tracking model can better determine associations between tracked subjects over time, for example to recover occluded subjects and/or to enhance robustness in tracking objects across discontinuities in image data due to dynamic and crowded environments. For example, the state management system may generate and update object states (e.g., associated with object IDs) using current behavior data (e.g., appearance and/or spatial/temporal data) extracted from the current behavior embeddings obtained from the spatial aggregation model. Incremental changes in either the appearance, location, and/or trajectory of a tracked subject may be iteratively updated and incorporated into behavior state data provided to the temporal tracking model.

As discussed, the output produced by the 3D-RTLS may comprise 3D object tracking data generated by the temporal tracking model in real-time that includes timestamped frames that include 3D bounding shapes and an object ID for respective tracked subjects within the monitored environment. In some embodiments, the 3D-RTLS may use the 3D object tracking data to render a user interface (UI) on a human-machine interface display. The UI may present a comprehensive computer vision-based view of the monitored environment. For example, the RTLS may use the location and/or trajectory data to display corresponding bounding shapes to indicate a predicted location and/or tracking information associated with each tracked subject. In some embodiments, the 3D-RTLS may generate a computer vision-based BEV display and/or a top-down view of the monitored area-displaying the location and/or tracking of each tracked subject. In some embodiments, the 3D-RTLS may generate a display of a computer vision-based environment corresponding to a viewpoint of one or more of the real image sensors providing the real-time live streaming data, and/or of a viewpoint of one or more virtual camera views instantiated within the computer vision-based environment.

In some embodiments, a tracked subject may be selected via the user interface and their movements tracked through the computer vision-based environment based on the 3D object tracking data. An object ID (or another corresponding identifier) may be displayed for one or more of the subjects tracked through the monitored environment. In some embodiments, the RTLS may generate an output representing data from the behaviors of one or more of the objects being tracked in the monitored environment. The output may be used as input for other systems. For example, in some embodiments, a navigation control system for a mobile machine, such as an autonomous mobile robot (AMR) and/or an ego machine, may dynamically route the mobile machine away from using a path that may be congested by the presence of tracked subjects (e.g., people) on the path. In other embodiments, the output from the 3D-RTLS may be used by a security system to track a person of interest in real-time as they traverse through the monitored environment.

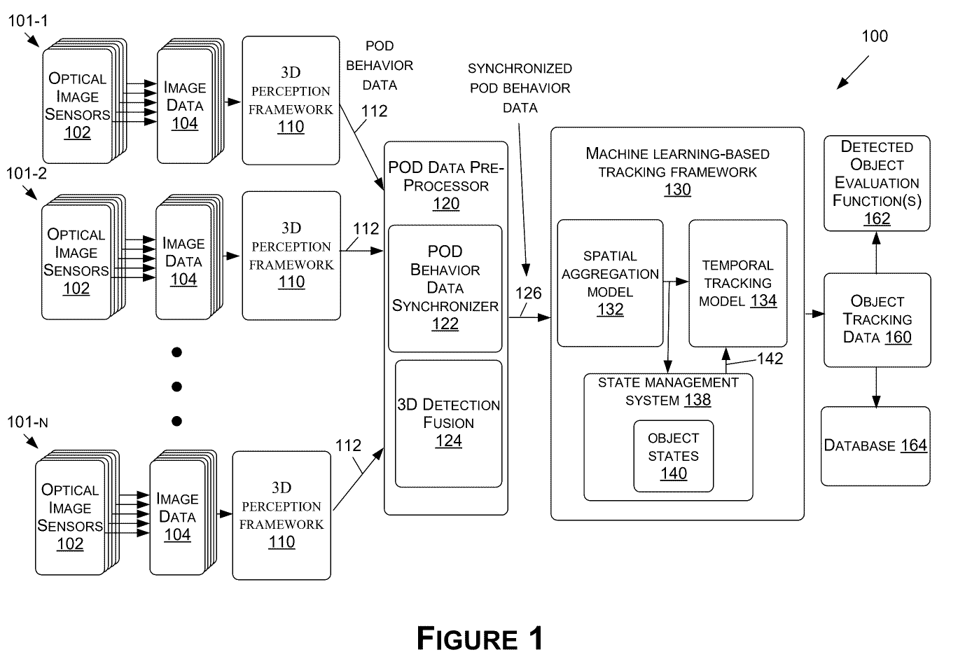

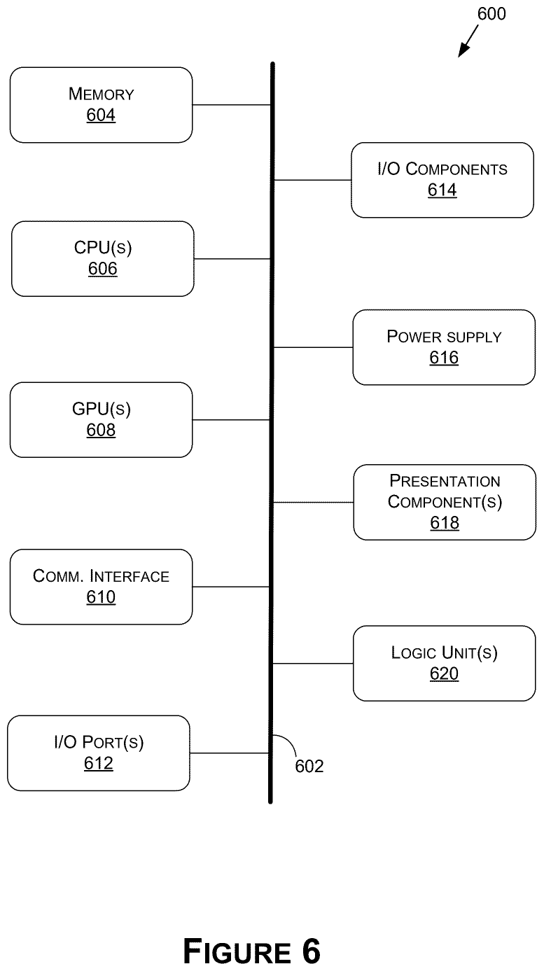

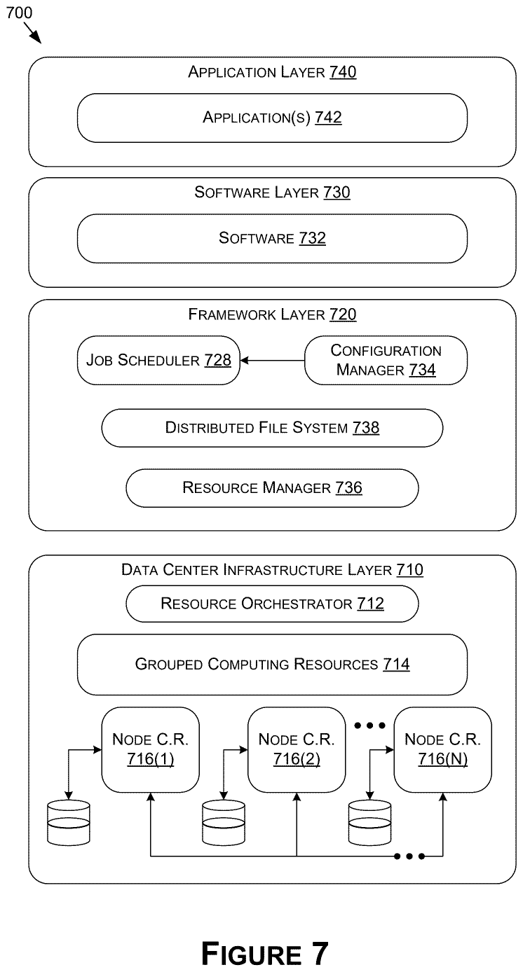

FIG. 1 is an example data flow diagram for a 3D perception-based Real-Time Location System (3D-RTLS), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors (e.g., processing units, processing circuitry, etc.) executing instructions stored in memory. In some embodiments, the systems, methods, and processes described herein may be executed using similar components, features, and/or functionalities to those of example computing device 600 of FIG. 6, and/or example data center 700 of FIG. 7.

As shown in FIG. 1, the 3D-RTLS 100 may receive image data 104 from a plurality of optical image sensors 102 (e.g., cameras) deployed across a monitored environment to track the location and/or trajectory of a plurality of entities (e.g., objects, people, robots, etc.) across the monitored environment. The 3D-RTLS 100 may obtain sets of behavior data 112 (e.g., BEV behavior data) where an individual set may represent behavior data associated with a defined “pod” or “group” of the optical image sensors 102. As shown in FIG. 1, the plurality of optical image sensors 102 that monitor the environment may be divided into image sensor groups or pods 101 (shown in FIG. 1 as image sensor pods 101-1 to 101-n). The plurality of optical image sensors 102 may be assigned to an image sensor pod 101, for example, based on the proximity and/or overlap and/or their individual fields of view. That is, an individual optical image sensor 102 may capture optical image data 104 (e.g., BEV sensor data) that represents a field of view covering at least a region of the monitored environment as viewed by that optical image sensor 102, whereas a pod 101 of optical image sensors 102 captures optical image data 104 representing a cumulative field of view corresponding to the combined fields of view of the individual image sensors 102 that make up that image sensor pod 101. In some embodiments, an image sensor pod 101 (e.g., optical image pod 101-1) may capture images from a field of view that at least partially overlaps with a field of view of another of the image sensor pod 101 (e.g., optical image pod 101-2). In various embodiments, optical image data 104 may include data generated by monocular and/or stereo image sensors 102.

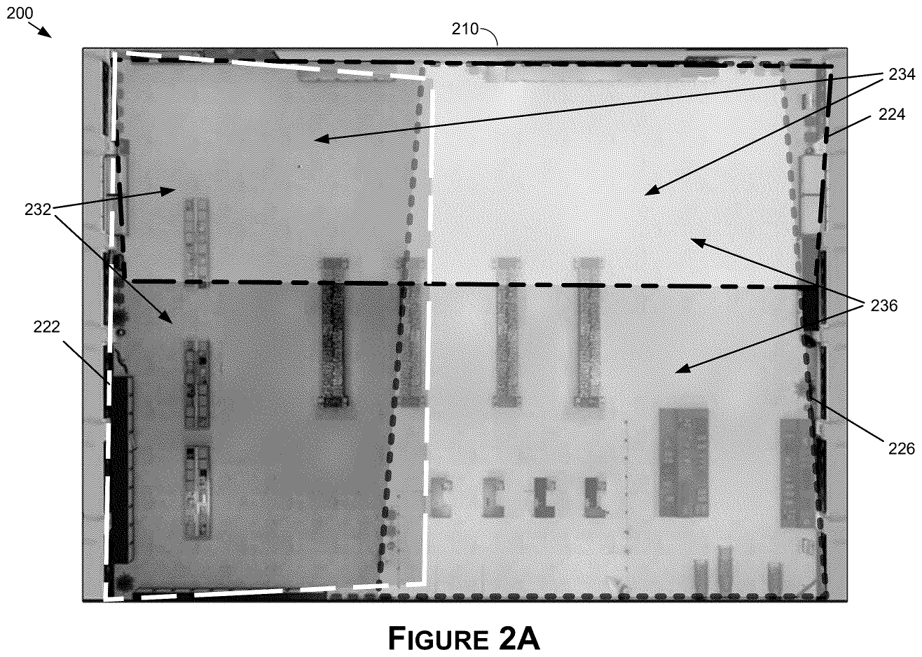

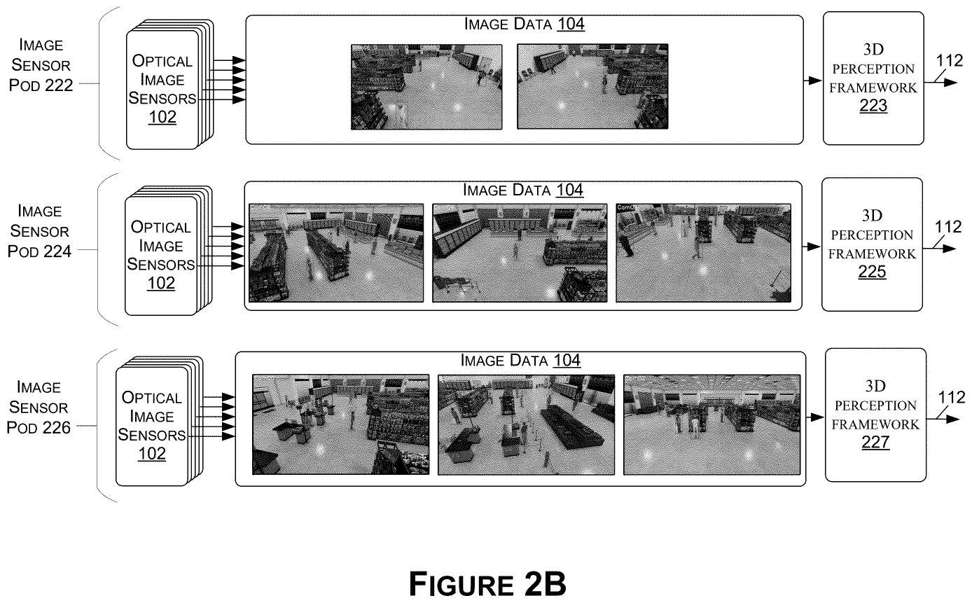

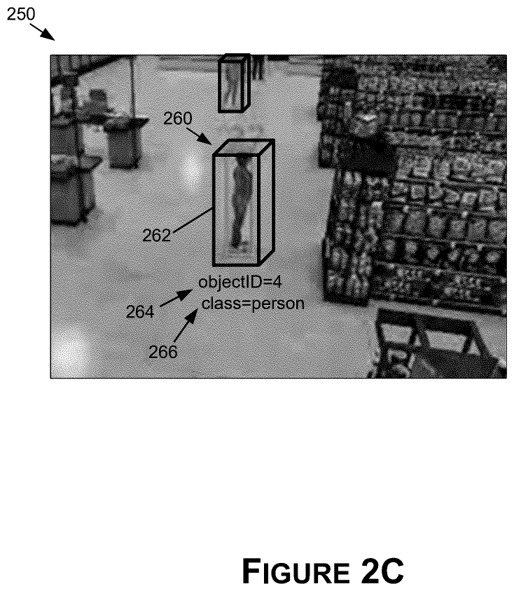

As shown in FIG. 1, optical image data 104 from an optical image sensor pod 101 may be fed as input to a 3D perception framework 110 that processes the optical image data 104 associated with that particular optical image sensor pod 101. The 3D perception framework 110 may process the optical image data 104 for an optical image sensor pod 101 to infer behavior data 112 for that pod 101, which may be referred to as pod behavior data 112. For example, FIG. 2A is a diagram at 200 of a monitored environment 210 and illustrates an example of grouping of optical image sensors 102 into image sensor pods 101. More specifically, in this example a first image sensor pod 222 may produce image data 104 from a first region 232 of the monitored environment 210, a second image pod 224 may produce image data 104 from a second region 234 of the monitored environment 210, and a third image pod may produce image data 104 from a third region 236 of the monitored environment 210. As shown in FIG. 2A, the region monitored by an image sensor pod may, in some implementations, at least partially overlap with the region monitored by another image sensor pod. Here, the monitored environment 405 is depicted in the form of a grocery store, but it should be appreciated that in various embodiments, the monitored environment 405 may comprise any area where object tracking is desired such as, but not limited to, warehouses, factories, retail establishments, hospitals, office buildings, secured facilities, arenas, public transportation stations, parks, public spaces, and the like. The image data pipelines associated with the image sensor pods 222, 224 and 226 are further illustrated by example in FIG. 2B. As shown in FIG. 2B, the image sensor pod 222 may comprise optical image sensors 102 that generate image data 104 that includes optical images from two fields of view that cover the first region 232. This image data 104 for image sensor pod 222 is provided to a 3D perception framework 223 (e.g., a 3D perception framework 110 as illustrated in FIG. 1) to produce pod behavior data 112 for the first region 232 covered by image sensor pod 222. The image sensor pod 224 may comprise optical image sensors 102 that generate image data 104 that includes optical images from three fields of view that cover the second region 234. This image data 104 for image sensor pod 224 is provided to a 3D perception framework 225 (e.g., a 3D perception framework 110 as illustrated in FIG. 1) to produce pod behavior data 112 for the second region 234 covered by image sensor pod 224. The image sensor pod 226 may comprise optical image sensors 102 that generate image data 104 that includes optical images from three fields of view that cover the third region 236. This image data 104 for image sensor pod 226 is provided to a 3D perception framework 227 (e.g., a 3D perception framework 110 as illustrated in FIG. 1) to produce pod behavior data 112 for the third region 236 covered by image sensor pod 226.

In some embodiments, the behavior data 112 may comprise BEV pod behavior data. As discussed herein, a 3D perception framework 110 may comprise a 3D perception-based machine learning framework having one or more machine learning models that input the optical image data 104 captured by the image sensors 102 of a pod 101, and infer the pod behavior data 112. A 3D perception framework 110 may initialize multiple 3D perception pipelines, wherein a 3D perception pipeline collects optical image data 104 from the image sensors 102 of a pod 101 and applies a model (e.g., a Sparse 4D-type architecture) to generate the set of the pod behavior data 112 for that pod 101. As a non-limiting example, in some embodiments, a 3D perception pipeline of a 3D perception framework 110 can process the image data 104 feed for 15 to 20 optical image sensors 102 that are grouped into a pod 101. Pod behavior data 112 comprises 3D information characterizing detected objects such as 3D bounding shapes (e.g., bounding boxes) corresponding to detected objects (e.g., entities such as objects, persons, animals, machines, etc.) within the combined field of view of the pod 101, an instance feature comprising high-dimensional semantics (e.g., an object classification correlated to a 3D bounding shape classifying an object as being, for example, a persons, a box, a forklift, etc.) and may include other metadata such as short-term tracking data for detected objects and/or image frame timestamps.

In some embodiments, the 3D perception framework 110 may further output object embeddings (e.g., behavior embeddings) that characterize the appearance of one or more features of a tracked subject, which support extended tracking scenarios across image sensor pods. An object embedding for a detected object may comprise an aggregation of object embeddings extracted from the multiple views of the object available from the optical image sensors 102 or a pod 101, and may serve as a unique characterization of a detected object that may be used for deriving a unique object ID for that object. For example, in some embodiments, a vector representing the object embedding itself may serve as an object ID for a detected object. In some embodiments, a vector representing the object embedding itself may be cross-referenced (e.g., via a lookup table) to a less complex identifier (e.g., a customer ID, equipment ID, package ID, employee ID, etc.) that serves as the object ID. The pod behavior data 112 for a given pod may be considered as representing behavior data for a virtualized composite sensor covering a particular monitoring region of the monitored environment. For illustrative purposes, FIG. 2C is a diagram providing a rendered illustration 250 of pod behavior data 112 that may be generated with respect to an individual detected object 260. As shown in FIG. 2C, for an individual detected object 260 behavior data may include a 3D bounding shape 262 (a 3D bounding box, in this example) that may indicate characteristics such as dimensions, shape, size, and/or orientation (rotation angle) of the detected object 260. In some embodiments, the behavior data may include a global ID 264 (e.g., an object ID that may derive from an object embedding) and/or an instance feature 266 (e.g., an object classification-a person, a box, a forklift, etc.).

In some embodiments, for each object detected by the 3D perception framework 110, multiple keypoints may be assigned and projected onto multi-view, multi-scale, and multi-timestamp image features to sample corresponding features. By using a 3D perception-based machine learning-based framework, a 3D perception framework 110 model may be trained on detecting the 3D bounding shapes, resulting in more reliable localization and tracking results in 3D space, and providing pod behavior data 112 that may be more readily leveraged by the subsequent machine learning-based tracking framework 130 discussed herein. Having 3D bounding shapes produced by the 3D perception framework 110 around a tracked subject may generate a richer dataset of pod behavior data 112 for further processing than merely having 3D location data for a tracked subject, because a 3D bounding shape can further indicate characteristics such as dimensions, shape, size, and/or angle of the detected object. Moreover, object embeddings incorporated in the pod behavior data 112 may be used to derive object IDs to track objects, and augment the context available for the machine learning-based tracking framework 130 to recognize associations between 3D bounding shapes, while realizing a less complex 3D perception-based detection pipeline as compared to prior approaches.

In some embodiments, the 3D-RTLS 100 may comprise a pod data preprocessor 120 and the machine learning-based tracking framework 130. The pod data preprocessor 120 receives the pod behavior data 112 from the individual 3D perception framework 110 for the image sensor pods 101 (e.g., 101-1 and 101-2 to 101-n) that cover the monitored environment. The pod data preprocessor 120 may include a POD behavior data synchronizer 122 that receives the pod behavior data 112 from the plurality of pods 101 and synchronizes the metadata of the pod behavior data 112 across the multiple optical image sensor pods 101 with respect to temporal alignment. In some embodiments, the pod data preprocessor 120 may include a 3D detection fusion function 124 that fuses 3D detection results with single-camera tracking outputs, creating a unified dataset for further processing by the machine learning-based tracking framework 130.

The output from the pod data preprocessor 120 comprises synchronized pod behavior data 126 (e.g., representing a synchronized composite of the pod behavior data 112 across the pods 101-1 to 101-n) which may be applied as input to the machine learning-based tracking framework 130. The machine learning-based tracking framework 130 may comprise a spatial aggregation model 132, a temporal tracking model 134, and/or a state management system 138.

The spatial aggregation model 132 may receive the synchronized pod behavior data 126 and perform a spatial aggregation of that 3D perception data across the sensor pods 101—that is, the spatial aggregation model 132 combines the pod behavior data 112 from the multiple optical image sensor pods 101 into a composite spatial representation (e.g., a BEV representation) of their fields of view to produce a comprehensive aggregation of the monitored environment as observed by the full complement of optical image sensor 102. By aggregating the detected object data represented by the synchronized pod behavior data 126, the spatial aggregation model 132 can simultaneously process behavior data corresponding to multiple detected objects as observed by hundreds (or thousands) of optical image sensors 102 throughout the monitored environment-making the 3D-RTLS 100 suitable for monitoring large-scale environments such as warehouses, urban spaces, and autonomous logistics operations. Moreover, this aggregation of pod behavior data addresses challenges such as occlusions and overlapping objects by leveraging relationships within and across the image sensor pods 101. The output produced by the spatial aggregation model 132 may comprise an aggregated dataset representing the entire monitored area. The spatial aggregation model 132 may aggregate the pod behavior data into a topic map, where each detected object may be represented by its own 3D bounding shape and tagged with its assigned object ID. In some embodiments, to address partially overlapping behavior data, the spatial aggregation model 132 may deduplicate bounding shapes by combining bounding shapes in overlapping regions and assigning an object ID to the resulting bounding shape.

The resulting aggregated dataset may be fed from the spatial aggregation model 132 to the temporal tracking model 134. The temporal tracking model 134 may associate detected objects across time (e.g., across a sequence of data frames) to establish consistency in object ID so that consistent global IDs may be maintained for long-term object tracking. Additionally, the temporal tracking model 134 facilitates recovery from object occlusions and abrupt detected object movements by associating currently tracked objects with previously detected and tracked objects from prior frames. In some embodiments, the temporal tracking model 134 may mitigate object tracking discontinuities by using prior frame tracking and position data to predict a current position for an object and associating that prediction with a presently observed detected object. The temporal tracking model 134 may implement extended object tracking beyond the limited tracking abilities of the 3D perception framework 110. That is, the temporal tracking model 134 may leverage a sufficiently larger lookback window to resolve uncertainties or ambiguities in object tracking over longer periods. The output from the temporal tracking model may be generated in real-time, including timestamps, 3D bounding shapes, and/or a global object ID for the individual detected objects observed across the image sensor pods 101.

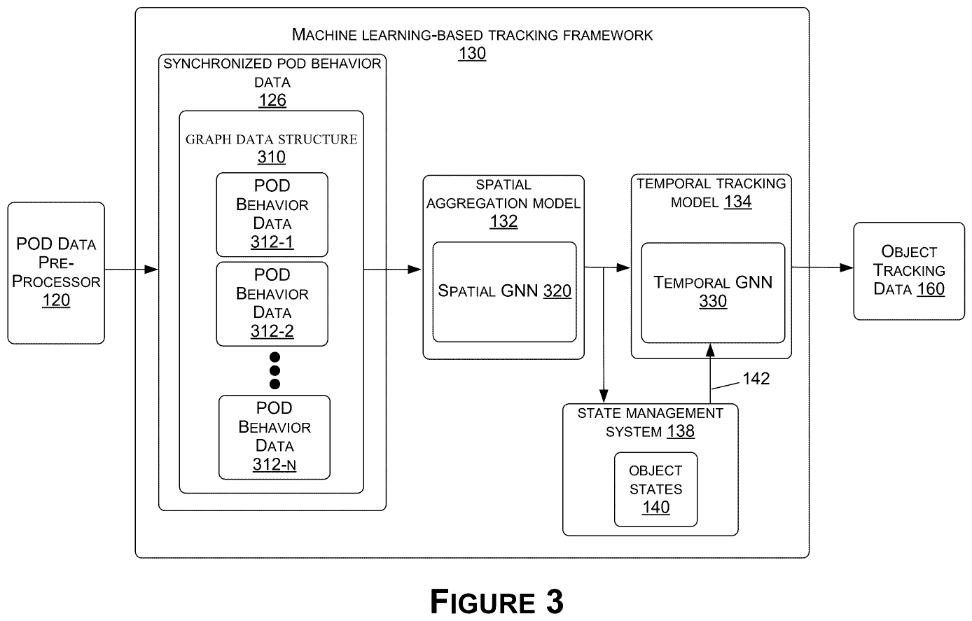

As illustrated in FIG. 3, in some embodiments, one or both of the spatial aggregation model 132 and/or the temporal tracking model 134 as described herein may comprise and be implemented using graph neural networks (GNNs). For example, in some embodiments, the machine learning-based tracking framework 130 may be implemented using a spatial aggregation model 132 that comprises a spatial GNN 320 and/or a temporal tracking model 134 that comprises a temporal GNN 330. For example, the synchronized pod behavior data 126 as processed by the machine learning-based tracking framework 130 may comprise a graph data structure 310 that comprises a non-linear structure of vertices (nodes) and edges, with a construction such that each edge in the graph data structure will correspond to a specific detected and/or tracked object represented in the synchronized pod behavior data 126. The pod behavior data 112 corresponding to the individual image sensor pods 101-1 and 101-2-101-n may be represented as graph data in the graph data structure 310, as shown in FIG. 3 as pod behavior data 312-1 and 312-2-312-n. In some embodiments, the synchronized pod behavior data 126 may be received from the pod data preprocessor 120 in the form of the graph data structure 310. In some embodiments, the machine learning-based tracking framework 130 may receive the synchronized pod behavior data 126 in another format, and generate the graph data structure 310 using the received synchronized pod behavior data 126. The spatial aggregation model 132 and/or the temporal tracking model 134 may operate to implicitly model interactions between detected objects (e.g., subjects such as people, objects, animals, machines, etc.) represented in the graph data structure 310. As such, if the graph data structure 310 has an edge that has a valid connection to another, then the detected object cannot correspond to any of the other edges in the graph, and for any given vertices (e.g., nodes), only one of the incident edges connected to that node can be true.

To train such machine learning models for the spatial aggregation model 132 and/or the temporal tracking model 134, the models may be provided training data comprising behavior data (e.g., embeddings associated with detected and tracked objects) with ground truth 3D bounding shapes across different batches, so that the spatial aggregation model 132 and/or the temporal tracking model 134 learn to associate those with a persistent object ID associated with the same tracked object. In some embodiments, the spatial aggregation model 132 and/or the temporal tracking model 134 may be implemented using other machine learning architecture. For example, in some embodiments, machine learning transformer models may be trained to perform the functions of the spatial aggregation model 132 and/or the temporal tracking model 134. For example, in some embodiments, an architecture similar to a GNN may be implemented using a transformer where message passing steps of a GNN are performed using one or more layers of a transformer model trained to mimic the message passing function.

With further reference to FIG. 1, the machine learning-based tracking framework 130 may comprise a state management system 138. The state management system 138 may function to augment the inputs into the temporal tracking model 134 to further enhance detected object tracking for extended periods of time. For example, in some embodiments, the state management system 138 may receive location and/or trajectory information for tracked subjects from the output of the spatial aggregation model 132 and maintain object states 140 (e.g., for extended periods of tracking time such as up to 10 seconds or more) so that the temporal tracking model 134 can better determine associations between tracked objects over time. For example, extended periods of tracking may facilitate recovery of temporarily occluded tracked objects and/or may enhance robustness in tracking objects across other types of discontinuities in image data due to dynamic and crowded environments or equipment (e.g., camera, cabling, area lighting, etc.) operational anomalies. For example, the state management system 138 may generate and update object states 140 (e.g., that may be correlated with object IDs) using current behavior data extracted from the current behavior embeddings obtained from the spatial aggregation model 132. Incremental changes in either the appearance, location, and/or trajectory of a tracked subject may be iteratively updated and incorporated into behavior state data 142 provided to the temporal tracking model 134.

The output produced by the 3D-RTLS may comprise 3D object tracking data 160 generated by the temporal tracking model 134. The 3D object tracking data 160 may include, for example, one or more of 3D bounding shapes, tracking data, instance data (semantics data such as an object classification) and/or an object ID (e.g., derived from and/or referenced to an object embedding) for the individual tracked objects detected by the machine learning-based tracking framework 130 based on pod behavior data 112. In some embodiments, the 3D object tracking data 160 may be used as input, for example, by one or more detected object evaluation functions 162 (e.g., analytics, query, and/or rendering systems). For example, the subject evaluation function(s) 162 may comprise a query-by-example (QBE) functionality, utilizing global IDs and behavior embeddings produced by the 3D-RTLS 100. Behavior embeddings and/or other behavior data from the 3D object tracking data 160 associated with one or more tracked objects may be stored in a database 164 (e.g., a Milvus database, vector database, and/or other vector database management system (VDBMS)) to support long-term QBE queries spanning over selected time periods. In some embodiments, the QBE functionality may operate based on representational state transfer (REST) application programming interface (API) inputs, that may include one or more of, but not limited to, an object ID, a sensor ID, a timestamp, optional parameters like time range, match score threshold, and/or top K matches, for obtaining similar behaviors. The QBE functionality may normalize object embeddings and/or 3D bounding shape data before searching in the database 164 for similar embeddings, and the matched behaviors may have IDs used by the REST API to fetch behavior metadata using a search engine (e.g., Elasticsearch). This search capability of the QBE functionality may provide for precise and efficient retrieval of relevant tracked subject behavior patterns over extended periods. In some embodiments, the object tracking data 160 may be generated based on queries performed using the QBE functionality. In some embodiments, the one or more detected object evaluation functions 162 may use 3D object tracking data 160 (and/or other data from the 3D-RTLS 100 representing detected objects) to control the operation of one or more machines and/or systems. For example, the detected object evaluation functions 162 may control one or more operations of an AMR and/or an ego machine, based on the location of the one or more of the tracked subjects as represented by the object tracking data 160.

In some embodiments, the one or more detected object evaluation functions 162 may include a rendering system to display via a UI a comprehensive view of the monitored area and visually render location and trajectory tracking data for each detected object in the monitored environment as indicated by the object tracking data 160. The rendering system may permit a user to switch between real and/or virtual camera views while tracking a subject moving through the monitored environment to locate a current position of a specific entity within the area (e.g., based on their object ID), and/or other applications that may benefit from having a real-time spatiotemporal understanding of the location and movements of subjects of interest within the monitored area.

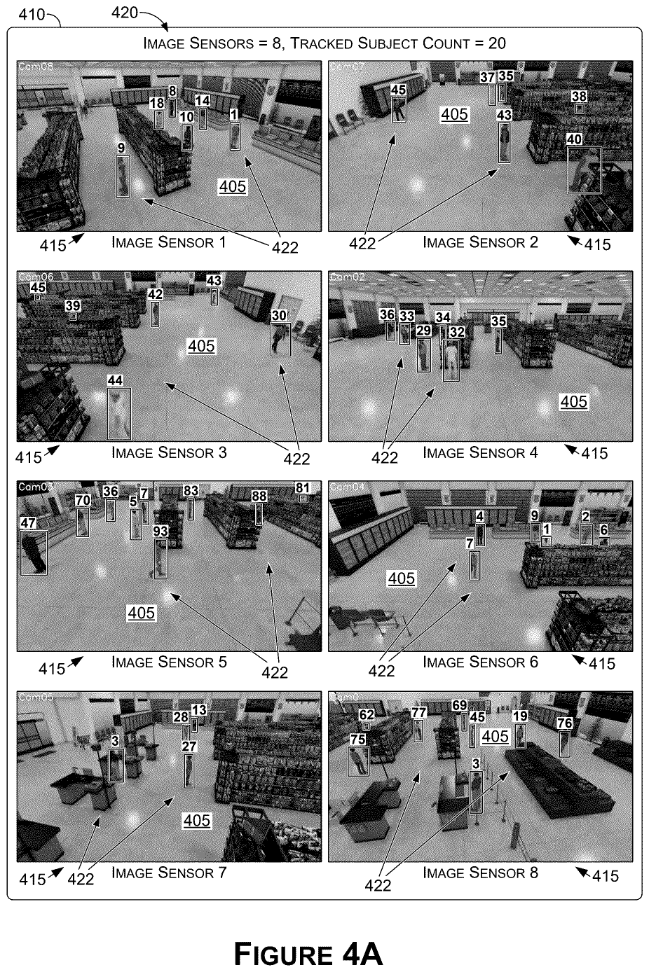

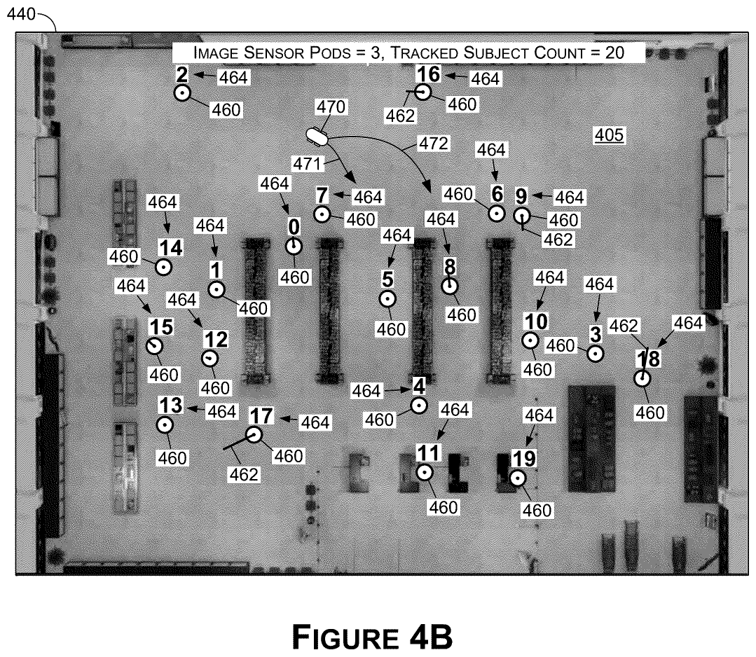

For example, FIGS. 4A and 4B are diagrams that illustrate example UIs that may be displayed using a human-machine interface coupled to the 3D-RTLS 100 (e.g., one or more of the presentation components 618 of example computing device(s) 600). In the examples of FIGS. 4A and 4B, the 3D-RTLS 100 may include a set of optical image sensors 102 that comprise a plurality of cameras arranged to view different portions of a monitored environment 405 (e.g., a monitored environment). The optical image sensors 102 may be grouped into distinct image sensor pods 101 as discussed herein. It should be understood that although FIGS. 4A and 4B illustrate an example embodiment of three image sensor pods comprising two or three optical image sensors, this is for illustrative purposes and in other embodiments, the plurality of optical image sensors 102 monitoring the monitored environment 405 may comprise any number of optical image sensors 102 (e.g., tens, hundreds, or thousands), that those optical image sensors 102 may be grouped into any number of image sensor pods 101, and that any individual image sensor pod 101 may comprise any plurality of optical image sensors.

In this figure, the monitored environment 405 is depicted in the form of a grocery store, but it should be appreciated that in various embodiments, the monitored environment 405 may comprise any area where object tracking is desired such as, but not limited to, warehouses, factories, retail establishments, hospitals, office buildings, secured facilities, arenas, public transportation stations, parks, public spaces, and the like. In FIG. 4A, a UI display 410 presents a plurality of views 415 of the monitored environment 405, referenced as Image Sensors 1-8. In some embodiments, each of the views 415 may correspond to an image feed from a distinct one of the optical image sensors 102, or a computer vision-generated composite view of one of the optical image sensors 102. In some embodiments, the 3D-RTLS 100 may generate one or more of the views 415 as a display of a computer vision-based environment corresponding to a BEV viewpoint of one or more of the optical image sensors 102, and/or of a viewpoint of one or more virtual camera views instantiated within the computer vision-based environment.

As shown in FIG. 4A, each of the views 415 may present a plurality of detected objects 422, each corresponding to behavior data associated with a tracked subject within the view of the respective image sensor. In some embodiments, the 3D-RTLS 100 may display a global ID (or other individual identifier) next to their associated 3D bounding shape. In some embodiments, UI display 410 may include an information field 420 displaying information about observed tracked objects, such as the number of tracked objects presented across the multiple views 415 and/or the number of optical image sensors 102 contributing optical image data 104 to produce the views 415. FIG. 4B is an example UI display 440 presenting a top-down view of the monitored environment 405. In some embodiments, the UI display 440 presents virtual objects 460 (e.g., virtual people, robots, machinery, etc.) at the positions of individual tracked objects corresponding to the detected objects in the 3D object tracking data 160 as tracked by the 3D-RTLS 100. For example, in some embodiments, each of the detected objects represented by the 3D object tracking data 160 may be rendered as a virtual object 460 as shown in FIG. 4B. In some embodiments, spatiotemporal data for each detected object (e.g., based on their respective 3D bounding shape data) may be mapped to a global coordinate system of the monitored environment 405 so that the position of tracked subjects may be presented using the virtual objects 460 with respect to a common frame of reference within the UI display 440.

As the 3D object tracking data 160 is updated, the 3D-RTLS 100 may update the position and/or appearance of each virtual object 460 representation of a tracked object within the UI display 440. For each virtual object 460, the UI display 440 may include a global ID 464 (e.g., an object ID derived from an object embedding). In some embodiments, for one or more of the virtual objects 460, the 3D-RTLS 100 may update a path indicator 462 that illustrates a tracked object's past positions and/or movements over a selectable duration of time.

As discussed herein, in some embodiments, the detected object evaluation functions 162 may control one or more operations of an AMR and/or an ego machine, based on the location of the one or more of the tracked subjects as represented by the object tracking data 160. In some embodiments, the UI display 440 may display the positions and/or movements of virtual objects 460 representing tracked objects in the monitored environment 405 in relation to the positions and/or movements of one or more AMRs 470. In some embodiments, the UI display 440 may display alternate routes 471 and 472 for navigating the AMR 470 through the monitored area that avoid congestion and/or avoid interactions with tracked subjects, and/or display route-changing events due to blockages.

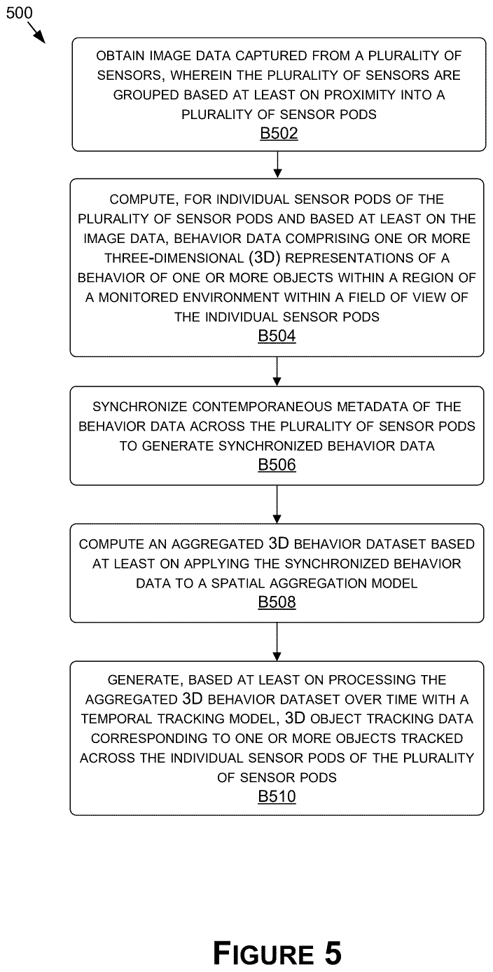

FIG. 5 is a flow diagram showing a method 500 for multi-sensor real-time subject tracking for monitored environments, in accordance with some embodiments of the present disclosure. It should be understood that the features and elements described herein with respect to the method 500 of FIG. 5 may be used in conjunction with, in combination with, or substituted for elements of any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa. Each block of method 500, described herein, comprises a computing process that may be performed using any combination of hardware, firmware, and/or software. For instance, various functions may be carried out by one or more processors comprising processing circuitry to execute instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the 3D-RTLS 100 of FIG. 1. However, the method may additionally or alternatively be executed by any one system, or any combination of systems, including, but not limited to, those described herein.

As discussed herein in greater detail, in some embodiments the method may generally include generating an output, from a real-time tracking system, of three-dimensional (3D) object tracking data representing a behavior of one or more objects within a region of a monitored environment, the 3D object tracking data generated based at least on behavior data for individual sensor pods of a plurality of sensor pods that define a grouping of sensors, the behavior data comprising one or more 3D representations of the behavior of the one or more objects, wherein the 3D object tracking data is computed based at least on: computing a 3D behavior dataset based at least on processing the behavior data with a spatial aggregation model; and computing, based at least on processing a sequence of data frames of the 3D behavior dataset with a temporal tracking model, an aggregation of the behavior of one or more objects across the individual sensor pods of the plurality of sensor pods.

The method 500, at block B502, includes obtaining image data captured from a plurality of sensors, wherein the plurality of sensors are grouped based at least on proximity into a plurality of sensor pods. As shown in FIG. 1, the plurality of optical image sensors 102 that monitor the environment may be divided into image sensor groups or pods 101 (shown in FIG. 1 as image sensor pods 101-1 to 101-n). The plurality of optical image sensors 102 may be assigned to an image sensor pod 101, for example, based on the proximity and/or overlap and/or their individual fields of view. That is, an individual optical image sensor 102 may capture optical image data 104 (e.g., BEV sensor data) that represent a field of view covering at least a region of the monitored environment as viewed by that optical image sensor 102, whereas a pod 101 of optical image sensors 102 captures optical image data 104 representing a cumulative field of view corresponding to the combined fields of view of the individual image sensors 102 that make up that image sensor pod 101. In some embodiments, an image sensor pod 101 (e.g., optical image pod 101-1) may capture images from a field of view that at least partially overlaps with a field of view of another of the image sensor pod 101 (e.g., optical image pod 101-2). FIG. 2A provided a diagram of a monitored environment 210 illustrating an example of grouping of optical image sensors 102 into image sensor pods 101.

The method 500, at block B504, includes computing, for individual sensor pods of the plurality of sensor pods and based at least on the image data, behavior data comprising one or more three-dimensional (3D) representations of a behavior of one or more objects within a region of a monitored environment within a field of view of the individual sensor pods. As shown in FIG. 1, optical image data 104 from an optical image sensor pod 101 may be fed as input to a 3D perception framework 110 that processes the optical image data 104 associated with that particular optical image sensor pod 101. The 3D perception framework 110 may process the optical image data 104 for an optical image sensor pod 101 to infer behavior data 112 for that pod 101, which may be referred to as pod behavior data 112. In some embodiments, a 3D perception framework 110 may initialize multiple 3D perception pipelines, wherein a 3D perception pipeline collects optical image data 104 from the image sensors 102 of a pod 101 and applies a model (e.g., a Sparse 4D-type architecture) to generate the set of the pod behavior data 112 for that pod 101. As a non-limiting example, in some embodiments, a 3D perception pipeline of a 3D perception framework 110 can process the image data 104 feed for 15 to 20 optical image sensors 102 that are grouped into a pod 101.

In some embodiments, the one or more 3D representations of the behavior may comprise, for a respective individual object of the one or more objects, at least a 3D bounding shape and a machine learning model-generated embedding that characterizes an appearance of one or more features of the respective individual object. As discussed herein, pod behavior data 112 comprises 3D information characterizing detected objects such as 3D bounding shapes (e.g., bounding boxes) corresponding to detected objects (e.g., entities such as objects, persons, animals, machines, etc.) within the combined field of view of the pod 101, an instance feature comprising high-dimensional semantics (e.g., an object classification correlated to a 3D bounding shape classifying an object as being, for example, a persons, a box, a forklift, etc.) and may include other metadata such as short-term tracking data for detected objects and/or image frame timestamps. For illustrative purposes, FIG. 2C is a diagram providing a rendered illustration 250 of pod behavior data 112 that may be generated with respect to an individual detected object 260.

In some embodiments, the method may include computing the behavior data based at least on processing the image data for the individual sensor pods using one or more neural networks. The one or more neural networks comprises a Sparse 4D model. As an example, by using a 3D perception-based machine learning-based framework, a 3D perception framework 110 model may be trained on detecting the 3D bounding shapes, resulting in more reliable localization and tracking results in 3D space, and providing pod behavior data 112 that may be more readily leveraged by the subsequent machine learning-based tracking framework 130 discussed herein. Having 3D bounding shapes produced by the 3D perception framework 110 around a tracked subject may generate a richer dataset of pod behavior data 112 for further processing than merely having 3D location data for a tracked subject, because a 3D bounding shape can further indicate characteristics such as dimensions, shape, size, and/or angle of the detected object. Moreover, object embeddings incorporated in the pod behavior data 112 may be used to derive object IDs to track objects, and augment the context available for the machine learning-based tracking framework 130 to recognize associations between 3D bounding shapes, while realizing a less complex 3D perception-based detection pipeline as compared to prior approaches.

The method 500, at block B506, includes synchronizing contemporaneous metadata of the behavior data across the plurality of sensor pods to generate synchronized behavior data. For example, the 3D-RTLS 100 may comprise a pod data preprocessor 120 that includes a pod behavior data synchronizer 122 that receives the pod behavior data 112 from the plurality of pods 101 and synchronizes the metadata of the pod behavior data 112 across the multiple optical image sensor pods 101 with respect to temporal alignment. In some embodiments, generating the synchronized behavior data may be further based at least on a fusion of the behavior data with tracking outputs associated with individual sensors of the plurality of sensors. For example, the pod data preprocessor 120 may include a 3D detection fusion function 124 that fuses 3D detection results with single-camera tracking outputs, creating a unified dataset for further processing by the machine learning-based tracking framework 130.

The method 500 at block B508 includes computing an aggregated 3D behavior dataset based at least on applying the synchronized behavior data to a spatial aggregation model. As discussed herein, the output from the pod data preprocessor 120 comprises synchronized pod behavior data 126 (e.g., representing a synchronized composite of the pod behavior data 112 across the pods 101-1 to 101-n) which may be applied as input to the machine learning-based tracking framework 130. The machine learning-based tracking framework 130 may comprise a spatial aggregation model 132, a temporal tracking model 134, and/or a state management system 138. The spatial aggregation model 132 may receive the synchronized pod behavior data 126 and perform a spatial aggregation of that 3D perception data across the sensor pods 101. That is, the spatial aggregation model 132 combines the pod behavior data 112 from the multiple optical image sensor pods 101 into a composite spatial representation (e.g., a BEV representation) of their fields of view to produce a comprehensive aggregation of the monitored environment as observed by the full complement of optical image sensor 102.

The method 500, at block B510, includes generating, based at least on processing the aggregated 3D behavior dataset over time with a temporal tracking model, 3D object tracking data corresponding to one or more objects tracked across the individual sensor pods of the plurality of sensor pods. The resulting aggregated dataset may be fed from the spatial aggregation model 132 to the temporal tracking model 134. The temporal tracking model 134 may associate detected objects across time (e.g., across a sequence of data frames) to establish consistency in object ID so that consistent global IDs may be maintained for long-term object tracking. Additionally, the temporal tracking model 134 facilitates recovery from object occlusions and abrupt detected object movements by associating currently tracked objects with previously detected and tracked objects from prior frames.

As discussed with respect to FIG. 3, the behavior data may comprise graph-structured data. The synchronized pod behavior data 126 as processed by the machine learning-based tracking framework 130 may comprise a graph data structure 310 that comprises a non-linear structure of vertices (nodes) and edges, with a construction such that each edge in the graph data structure will correspond to a specific detected and/or tracked object represented in the synchronized pod behavior data 126. The pod behavior data 112 corresponding to the individual image sensor pods 101-1 and 101-2-101-n may be represented as graph data in the graph data structure 310, as shown in FIG. 3 as pod behavior data 312-1 and 312-2-312-n. Also as discussed with respect to FIG. 3, at least one of the spatial aggregation model or the temporal tracking model may comprise one or more graph neural networks (GNNs) or one or more transformer-based machine learning models. For example, in some embodiments, the machine learning-based tracking framework 130 may be implemented using a spatial aggregation model 132 that comprises a spatial GNN 320 and/or a temporal tracking model 134 that comprises a temporal GNN 330.

In some embodiments, the method may further include generating and updating object states of a state management system using behavior data extracted from behavior embeddings obtained from the spatial aggregation model, wherein the behavior embeddings that characterize an appearance of one or more features of a respective individual object of the one or more objects, wherein the temporal tracking model further generates the 3D object tracking data based at least on the object states. The machine learning-based tracking framework 130 may comprise a state management system 138. The state management system 138 may function to augment the inputs into the temporal tracking model 134 to further enhance detected object tracking for extended periods of time. For example, in some embodiments, the state management system 138 may receive location and/or trajectory information for tracked subjects from the output of the spatial aggregation model 132 and maintain object states 140 (e.g., for extended periods of tracking time such as up to 10 seconds or more) so that the temporal tracking model 134 can better determine associations between tracked objects over time.

In some embodiments, the method may include controlling an operation of a machine navigating through the monitored environment based at least on the 3D object tracking data. The one or more detected object evaluation functions 162 may use 3D object tracking data 160 (and/or other data from the 3D-RTLS 100 representing detected objects) to control the operation of one or more machines and/or systems. For example, the detected object evaluation functions 162 may control one or more operations of an AMR and/or an ego machine, based on the location of the one or more of the tracked subjects as represented by the object tracking data 160. In some embodiments, the method may cause a display of a computer vision-based view of the one or more tracked objects for at least part of the monitored environment based at least on the 3D object tracking data. For example, FIGS. 4A and 4B are diagrams that illustrate example UIs that may be displayed using a human-machine interface coupled to the 3D-RTLS 100. As shown in FIG. 4A, each of the views 415 may present a plurality of detected objects 422 each corresponding to behavior data associated with a tracked subject within the view of the respective image sensor. FIG. 4B is an example UI display 440 presenting a top-down view of the monitored environment 405. In some embodiments, the UI display 440 presents virtual objects 460 (e.g., virtual people, robots, machinery, etc.) at the positions of individual tracked objects corresponding to the detected objects in the 3D object tracking data 160 as tracked by the 3D-RTLS 100.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, simulated sensor data and/or map data may be used that includes image data captured by a plurality of fixed mounted optical image sensors deployed to monitor an environment within the simulation environment- and those optical image sensors are extrinsically calibrated together based on fixed mounted optical image sensor calibration parameters to produce a 3D reconstruction of the monitored environment. The simulation environment may use this image data and/or fixed mounted optical image sensor calibration parameter information to perform operations (e.g., navigating) associated with the virtual machine within the environment. These simulated operations may be used to test performance of the underlying algorithms, systems, and/or processes prior to deploying them in the real world. In some instances, the simulation may be used to generate synthetic training data—e.g., training data including regions of interest and/or subregions of interest from within the simulation. The synthetic training data (in addition to or alternatively from real-world data) may then be processed to determine geometry and/or other information related to road surfaces, for example. In any example, such as where a simulation environment is used for testing, validation, training, etc., the simulation environment and/or associated training data may be rendered or otherwise generated using one or more light transport algorithms-such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing a universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems-such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to produce processed image data related to animated or static objects, hazards, etc., which may be used or included in a visualization or mapping of an environment to aid a remote operator in controlling- or providing waypoints or other indications of control or navigation—an autonomous or semi-autonomous machine through an environment.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models), and memory and/or storage (e.g., for storing entertainment content, navigation data, and user preferences). The system may use these processors to execute one or more machine learning models to enable features such as occupant monitoring, gesture recognition, and real-time communication with other services through network connectivity. The in-vehicle infotainment system may also use natural language processing (NLP) models to enable voice-based interaction. The one or more machine learning models may be stored locally or accessed through one or more application programming interfaces (APIs) that connect to cloud services, enabling the system to process requests in real-time or near real-time.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers, etc.) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, vision language models (VLMs), large language models (LLMs), multimodal language models (MMLMs), diffusion models, NeRF models, deep neural networks (DNNs), etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some examples, the machine learning model(s) (e.g., deep neural networks, language models, LLMs, VLMs, multimodal language models, perception models, tracking models, fusion models, transformer models, diffusion models, encoder-only models, decoder-only models, encoder-decoder models, neural rendering field (NeRF) models, etc.) described herein may be packaged as one or more cloud-hosted microservices—such as an inference microservice(s) (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a preconfigured container for simplified deployment, an optimized inference engine (e.g., built using a standardized AI model deployment and execution software, such as NVIDIA's Triton Inference Server, and/or one or more APIs for high-performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device or up to data-center scale). As such, the inference microservice may include the machine learning model(s) (e.g., that has been optimized for high-performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, one or more aspects of the 3D-RTLS 100, 3D perception framework(s) 110, pod data preprocessor 120 and/or machine-learning based tracking framework 130, may be implemented at least in part by processing circuitry of computing device 600 (e.g., CPU(s) 606, GPU(s) 608 and/or logic unit(s) 620).

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

In some embodiments, one or more aspects of the 3D-RTLS 100, 3D perception framework(s) 110, pod data preprocessor 120 and/or machine-learning based tracking framework 130, may be executed at least in part by CPU(s) 606, GPU(s) 608 and/or logic unit(s) 220). For example, in some embodiments spatial aggregation model 132 and/or temporal tracking model 134 may comprise neural-network-based machine learning models executed by GPU(s) 608. In some embodiments, a machine learning model of a 3D perception framework 110 may comprise a neural-network-based machine learning model executed by GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality content.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, the 3D-RTLS-100 may present a representation of object tracking data 160 using a user interface (such as illustrated in FIGS. 4A, 4B) on presentation component(s) 618.

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740. In some embodiments, one or more aspects of the 3D-RTLS 100, 3D perception framework(s) 110, pod data preprocessor 120 and/or machine-learning based tracking framework 130, may be implemented at least in part by data center 700. For example, one or more functions of the 3D-RTLS 100, 3D perception framework(s) 110, pod data preprocessor 120 and/or machine-learning based tracking framework 130, may be implemented at least in part as network services (e.g., microservices) hosted by one or more servicer of data center 700.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM). In some embodiments, one or more aspects of the 3D-RTLS 100, 3D perception framework(s) 110, pod data preprocessor 120 and/or machine-learning based tracking framework 130, may be implemented at least in part by one or more of the node C.R.s 716(1)-716(N). For example, spatial aggregation model 132 and/or temporal tracking model 134 may be implemented on one or more vGPUs and/or vCPUs.

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources. In some embodiments, one or more aspects of the 3D-RTLS 100, 3D perception framework(s) 110, pod data preprocessor 120 and/or machine-learning based tracking framework 130, may be performed by executing one or more of applications 742 and/or software 732.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
obtain image data captured from a plurality of sensors, wherein the plurality of sensors are grouped based at least on proximity into a plurality of sensor pods;
compute, for individual sensor pods of the plurality of sensor pods and based at least on the image data, behavior data comprising one or more three-dimensional (3D) representations of a behavior of one or more objects within a region of a monitored environment within a field of view of the individual sensor pods;
synchronize contemporaneous metadata of the behavior data across the plurality of sensor pods to generate synchronized behavior data;
compute an aggregated 3D behavior dataset based at least on applying the synchronized behavior data to a spatial aggregation model; and
generate, based at least on processing the aggregated 3D behavior dataset over time with a temporal tracking model, 3D object tracking data corresponding to one or more objects tracked across the individual sensor pods of the plurality of sensor pods.

2. The one or more processors of claim 1, wherein the processing circuitry is further to:
cause a display of a computer vision-based view of the one or more tracked objects for at least part of the monitored environment based at least on the 3D object tracking data.

3. The one or more processors of claim 1, wherein the processing circuitry is further to:
control an operation of a machine navigating through the monitored environment based at least on the 3D object tracking data.

4. The one or more processors of claim 1, wherein the processing circuitry is further to:
compute the behavior data based at least on processing the image data for the individual sensor pods using one or more neural networks.

5. The one or more processors of claim 4, wherein the one or more neural networks comprises a Sparse 4D model.

6. The one or more processors of claim 1, wherein the one or more 3D representations of the behavior comprise, for a respective individual object of the one or more objects, at least a 3D bounding shape and a machine learning model-generated embedding that characterizes an appearance of one or more features of the respective individual object.

7. The one or more processors of claim 1, wherein the processing circuitry is further to:
generate the synchronized behavior data further based at least on a fusion of the behavior data with tracking outputs associated with individual sensors of the plurality of sensors.

8. The one or more processors of claim 1, wherein the behavior data comprises graph-structured data.

9. The one or more processors of claim 1, wherein at least one of the spatial aggregation model or the temporal tracking model comprises one or more graph neural networks (GNNs) or one or more transformer-based machine learning models.

10. The one or more processors of claim 1, wherein the processing circuitry is further to:
generate and update object states of a state management system using behavior data extracted from behavior embeddings obtained from the spatial aggregation model, wherein the behavior embeddings characterize an appearance of one or more features of a respective individual object of the one or more objects; and
wherein the temporal tracking model further generates the 3D object tracking data based at least on the object states.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more vision language models (VLMs);
a system implementing one or more large language models (LLMs);
a system implementing one or more multi-modal language models (MMLMs);
a system implemented using one or more cloud-hosted microservices;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

12. A system comprising one or more processors to:
obtain behavior data for individual sensor pods of a plurality of sensor pods, wherein the individual sensor pods define a grouping of sensors, the behavior data comprising one or more three-dimensional (3D) representations of a behavior of one or more objects within a region of a monitored environment within a field of view of the individual sensor pods;
compute an aggregated 3D behavior dataset based at least on applying synchronized behavior data to a machine learning spatial aggregation model, the synchronized behavior data determined based at least on a temporal alignment of the behavior data for the individual sensor pods across the plurality of sensor pods; and
generate, based at least on processing a sequence of data frames of the aggregated 3D behavior dataset with a temporal tracking model, 3D object tracking data representing an aggregation of the one or more objects across the individual sensor pods of the plurality of sensor pods.

13. The system of claim 12, wherein the one or more 3D representations of the behavior comprise, for respective individual objects of the one or more objects, at least a 3D bounding shape and a machine learning model-generated embedding that characterizes an appearance of one or more features of the respective individual object.

14. The system of claim 12, wherein the behavior data comprises graph-structured data.

15. The system of claim 12, wherein at least one of the machine learning spatial aggregation model or the temporal tracking model comprises one or more graph neural networks (GNNs) or one or more transformer-based machine learning models.

16. The system of claim 12, wherein the one or more processors are further to:
compute the behavior data based at least on processing image data captured from a plurality of sensors associated with the individual sensor pods using a 3D perception-based machine learning framework.

17. The system of claim 12, wherein the one or more processors are further to:
generate and update object states of a state management system using behavior data extracted from behavior embeddings obtained from the machine learning spatial aggregation model, wherein the behavior embeddings characterize an appearance of one or more features of a respective individual object of the one or more objects; and
wherein the temporal tracking model further generates the 3D object tracking data based at least on the object states.

18. The system of claim 12, wherein the one or more processors are further to:
cause a display of a computer vision-based view of the one or more objects for at least part of the monitored environment based at least on the 3D object tracking data.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more vision language models (VLMs);
a system implementing one or more large language models (LLMs);
a system implementing one or more multi-modal language models (MMLMs);
a system implemented using one or more cloud-hosted microservices;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
generating an output, from a real-time tracking system, of three-dimensional (3D) object tracking data representing a behavior of one or more objects within a region of a monitored environment, the 3D object tracking data generated based at least on behavior data for individual sensor pods of a plurality of sensor pods that define a grouping of sensors, the behavior data comprising one or more 3D representations of the behavior of the one or more objects, wherein the 3D object tracking data is computed based at least on:
computing a 3D behavior dataset based at least on processing the behavior data with a spatial aggregation model; and
computing, based at least on processing a sequence of data frames of the 3D behavior dataset with a temporal tracking model, an aggregation of the behavior of one or more objects across the individual sensor pods of the plurality of sensor pods.
